(19) United States
(12) Patent Application Publication
(10) Pub. No.: US 2005/0169346 A1
(43) Pub. Date: Aug. 4, 2005

(54) Method for monitoring quality of a transmissive laser weld

(75) Inventors: Neil G. Murray JR., Wixom, MI (US); Douglas W. Benefiel, West Terre Haute, IN (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive U.S. LLC

(21) Appl. No.: 10/767,798

(22) Filed: Jan. 29, 2004

(51) Int. Cl. G01N 25/00

(52) U.S. Cl. 374/121

(57) ABSTRACT

A method for monitoring quality of a weld (56) being formed between first and second pieces of material (10 and 12) includes the steps of obtaining a thermal image of the weld (56) being formed by collecting infrared radiation passing through the second piece of material (12); and analyzing the obtained thermal image for characteristics indicative of a properly formed weld (56).

### TECHNICAL FIELD

The present invention relates to a method for monitoring the quality of a weld being formed between two pieces of material. More particularly, the present invention relates to a method for monitoring the quality of a transmissive laser weld being formed between two pieces of plastic material.

### BACKGROUND OF THE INVENTION

Transmissive laser welding is used for bonding together first and second pieces of plastic material. The weld in transmissive laser welding is formed using a beam of electromagnetic energy that is emitted from a laser. One of the two pieces of plastic material, for example, the first piece of plastic material, is transmissive to the beam of electromagnetic energy, i.e., the beam passes through the first piece of plastic material. The other of the two pieces of plastic material, for example, the second piece of plastic material, absorbs the electromagnetic energy of the beam.

During the transmissive laser welding process, the beam of electromagnetic energy emitted from the laser passes through the first piece of plastic material and is absorbed by the second piece of plastic material. The absorbed electromagnetic energy heats a portion of the second piece of plastic material and the heated portion of the second piece of plastic material begins to melt. Also, heat of the heated portion of the second piece of plastic material is conducted to an adjacent portion of the first piece of plastic material. The adjacent portion of the first piece of plastic material also begins to melt. The melted portions of the first and second pieces of plastic material collectively form a weld pool in which the melted portions of the first and second pieces of plastic material mix together. When the electromagnetic energy is removed, the weld pool begins to cool and hardens into a weld that bonds together the first and second pieces of plastic material.

Many problems can occur during the formation of a transmissive laser weld. For example, when a portion of the weld pool is not heated to a proper temperature, i.e., the temperature of the portion is too low, the width of the weld pool at that portion may be too narrow and a weak point or even a void in the weld may result. On the other hand, when a portion of the weld pool is overheated, i.e., the temperature of the portion is too high, gas voids may form in the weld pool. As the weld pool cools, the gas voids may result in weak points or voids in the weld.

Thus, it is desirable to monitor the formation of the weld during the transmissive laser welding process to ensure that a quality weld is being formed between the first and second pieces of plastic material. Currently, the formation of a transmissive laser weld is monitored using an infrared pyrometer. The infrared pyrometer monitors the temperature of the weld pool at a single point that is located immediately behind the beam of electromagnetic energy. The infrared pyrometer is turned off when the laser is turned off.

One drawback to the use of the infrared pyrometer is that the infrared pyrometer is limited to monitoring the temperature of a single point of the weld pool at a time. Thus, the infrared pyrometer is not capable of sensing temperature changes of the weld pool that occur over time, for example, during the period of time that another portion of the weld pool is being heated.

### SUMMARY OF THE INVENTION

The present invention relates to a method for monitoring quality of a weld being formed between first and second pieces of material. The method comprises the steps of: obtaining a thermal image of the weld being formed by collecting infrared radiation passing through the second piece of material; and analyzing the obtained thermal image for characteristics indicative of a properly formed weld.

According to another aspect, the present invention relates to a method for monitoring quality of a weld being formed between first and second pieces of material. The method comprises the steps of: determining a range of wavelengths of infrared radiation that will pass through the second piece of material; positioning an infrared detector that is configured to detect infrared radiation within the determined range of wavelengths on a side of the second piece of material opposite the first piece of material; obtaining a thermal image of the weld being formed between the first and second pieces of material by collecting infrared radiation within the determined range of wavelengths; and analyzing the obtained thermal image for characteristics indicative of a properly formed weld.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 schematically illustrates first and second pieces of plastic material that are being welded together and an apparatus for performing the method of the present invention;

FIG. 2 is a top view illustrating the first and second pieces of plastic material during formation of the weld; and

FIGS. 3A and 3B collectively form a flow diagram that illustrates an exemplary control process that may be performed in accordance with the method of the present invention.

### DETAILED DESCRIPTION OF THE INVENTION

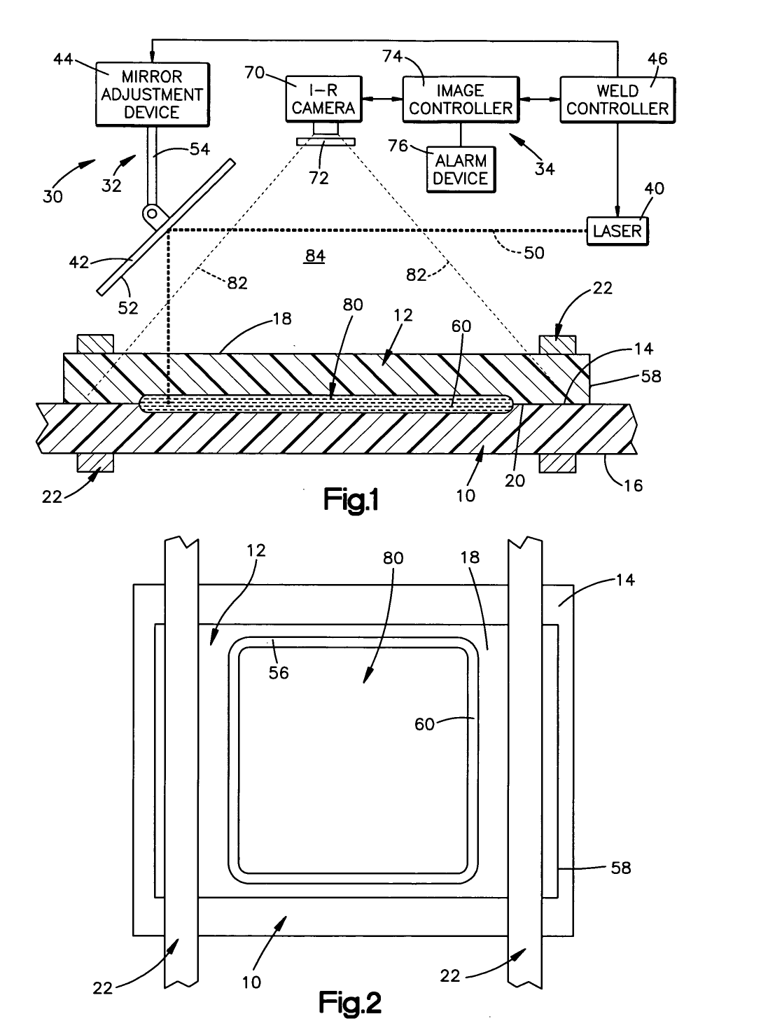

FIG. 1 schematically illustrates first and second pieces of plastic material 10 and 12, respectively. The first piece of plastic material 10 is generally planar and includes upper and lower surfaces 14 and 16, respectively. Similarly, the second piece of plastic material 12 is generally planar and includes upper and lower surfaces 18 and 20, respectively. FIG. 1 illustrates the second piece of plastic material 12 overlaying the first piece of plastic material 10. Two clamping devices 22 are illustrated in FIG. 1 holding the first and second pieces of plastic material together. When the first and second pieces of plastic material 10 and 12 are held together, the upper surface 14 of the first piece of plastic material 10 abuts the lower surface 20 of the second piece of plastic material.

The first and second pieces of plastic material 10 and 12 have different material properties. Particularly, the second piece of plastic material 12 is transmissive to a range of infrared wavelengths, while the first piece of plastic material 10 absorbs the same range of infrared wavelengths. The second piece of plastic material 12 may be transparent to the range of infrared wavelengths or may be translucent to the range of infrared wavelengths. This range of infrared wavelengths is determined prior to beginning the transmissive laser welding process.

FIG. 1 also schematically illustrates an apparatus 30 for performing the method of the present invention. The apparatus 30 includes a welding portion 32 and a monitoring portion 34. The welding portion 32 includes devices for forming a transmissive laser weld to bond together the first and second pieces of plastic material 10 and 12. These devices include a laser 40, mirror 42, a mirror adjustment device 44, and a weld controller 46.

The laser 40 of the welding portion 32 of the apparatus 30 is actuatable to provide a beam 50 of electromagnetic energy having a wavelength that is within the range of wavelengths determined to be transmissive to the second piece of plastic material 12 and determined to be absorptive to the first piece of plastic material 10. As illustrated in FIG. 1, the laser 40 is fixed in a located above the first and second pieces of plastic material 10 and 12 and directs the beam 50 of electromagnetic energy in a direction generally parallel to the upper surfaces 14 and 18 of the first and second pieces of plastic material 10 and 12.

The mirror 42 of the welding portion 32 of the apparatus 30 includes a reflective surface 52 for reflecting the beam 50 of electromagnetic energy from the laser 40 toward the first and second pieces of plastic material 10 and 12. The mirror adjustment device 44 is coupled to the mirror 42 and controls the positioning of the mirror 42. FIG. 1 shows an actuator arm 54 of the mirror adjustment device 44 being fixedly attached to the mirror 42. The mirror adjustment device 44 is actuatable for changing the position of the mirror 42 and thus, changing the angle of the reflective surface 52 relative to the laser 40. Changes in position of the mirror 42 result in a movement of the beam 50 of electromagnetic energy relative to the first and second pieces of plastic material 10 and 12.

The weld controller 46 of the welding portion 32 of the apparatus 30 is preferably a microcomputer. Alternatively, the weld controller 46 may be formed from discrete circuitry, an application-specific-integrated-circuit (“ASIC”), or any other type of control circuitry. The weld controller 46 is operatively coupled to the laser 40 and to the mirror adjustment device 44. The weld controller 46 controls actuation of the laser 40 and the mirror adjustment device 44 to form a weld of a predetermined shape between the first and second pieces of plastic material 10 and 12.

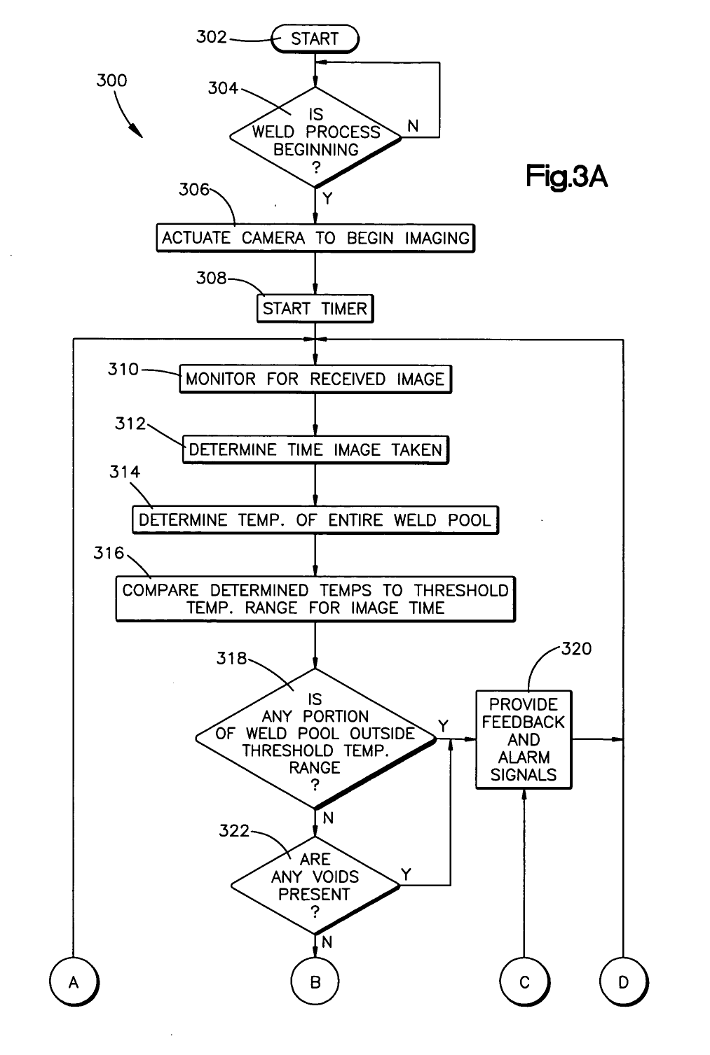

For example, with reference to FIG. 2, the weld controller 46 may control actuation of the laser 40 and the mirror adjustment device 44 to form a generally square-shaped weld, indicated at 56, near a periphery 58 of the second piece of plastic material 12. Weld 56 may be used, for example, for welding a cover piece formed from the second piece of plastic material 12 over an opening in a housing formed from the first piece of plastic material 10. In such an example, the opening in the housing would be located radially inside the weld 56 and the weld 56 would close the opening. The opening is not illustrated in FIGS. 1 and 2.

During the transmissive laser welding process, the weld controller 46 actuates the laser 40 to provide the beam 50 of electromagnetic energy. The weld controller 46 also controls the mirror adjustment device 44 for moving the mirror 42 so as to direction the beam 50 of electromagnetic energy over the desired weld path, e.g., the square-shaped path of weld 56 in FIG. 2. Since the beam 50 of electromagnetic energy has a wavelength in the range that is transmissive to the second piece of plastic material 12, the beam 50 of electromagnetic energy, after being reflected by the reflective surface 52 of the mirror 42, passes through the second piece of plastic material 12. Since the first piece of plastic material 10 is absorptive to the wavelength of the beam 50 of electromagnetic energy, the beam 50 of electromagnetic energy heats the first piece of plastic material 10 in a location adjacent the upper surface 14. The heat resulting from absorption of the beam 50 of electromagnetic energy begins to melt a portion the first piece of plastic material 10 in a location adjacent the upper surface 14. The heat is also conducted to the lower surface 20 of the second piece of plastic material 12 and begins to melt an adjacent portion of the second piece of plastic material 12.

Melted portions of the first and second pieces of plastic material 10 and 12 mix together to forms a weld pool 60 in a location between the first and second pieces of plastic material 10 and 12. As is discussed below, cooling of the weld pool 60 forms the weld 56 that bonds together the first and second pieces of plastic material 10 and 12. Thus, with reference to FIG. 2, the weld pool 60 has the identical, generally square-shape as the weld 56.

When forming weld pool 60, the weld controller 46 may control the mirror adjustment surface 44 so that the mirror 42 directs the beam 50 of electromagnetic energy over the path of weld pool 60 multiple times. For example, with reference to FIG. 2, the beam 50 of electromagnetic energy may start in the upper, right corner of the weld pool 60, as viewed in FIG. 2, and may be moved around the generally square-shaped path in a clockwise direction multiple times. By moving the beam 50 of electromagnetic energy around the path of weld pool 60 multiple times, a more uniform heating of the weld pool 60 occurs and the entire weld 56 may be formed simultaneously. By forming the entire weld 56 simultaneously, the occurrence of stress points within the weld 56 is reduced as compared to when the weld 56 is formed a portion at a time.

The monitoring portion 34 of the apparatus 30 includes an infrared camera 70, an optical filter 72, an image controller 74, and may optionally include an alarm device 76. The infrared camera 70 is positioned above the second piece of plastic material 12, as viewed in FIG. 1, on an side of the second piece of plastic material 12 opposite the first piece of plastic material 10. Preferably, the infrared camera 70 is centrally located above an area, indicated generally by 80, in which the weld 56 is to be formed to bond together the first and second pieces of material 10 and 12.

The infrared camera 70 has a field of view 84, shown in FIG. 1 as the area between dashed lines 82. The field of view 84 includes the area 80 in which the weld 56 is to be formed. The infrared camera 70 is configured for obtaining infrared images of the field of view 84 during the process of forming the weld 56. Thus, the infrared camera 70 obtains infrared images of the weld pool 60, in its entirety, during the process of forming the weld 56.

The infrared camera 70 may be a complimentary metal-oxide semiconductor (“CMOS”) camera, a charge-coupled device (“CCD”) camera, or any other type of infrared camera that is capable of collecting infrared radiation having a wavelength that is transmissive to the second piece of plastic material and is also capable of obtaining infrared images of the entire field of view 84. The infrared camera 70 is designed for imaging light in the range of infrared wavelengths that is transmissive to the second piece of plastic material 12 and is absorbed by the first piece of plastic material 10. Preferably, the infrared camera 70 obtains an infrared image of the viewable field 84 at a wavelength that is different than the wavelength of the beam 50 of electromagnetic energy that is emitted from the laser 40. As a result, the beam 50 of electromagnetic energy is not seen in the infrared images obtained by the infrared camera 70.

The optical filter 72 is associated with the infrared camera 70 and is located in the field of view 84 between the infrared camera 70 and the first and second pieces of plastic material 10 and 12. The optical filter 72 enables a range of wavelengths of light to pass through the filter and blocks wavelengths of light that are outside the range. Preferably, the range of infrared light that may pass through the optical filter 72 includes the wavelength of light obtained by the infrared camera 70 and does not include the wavelength of the beam 50 of electrical energy. For example, the beam 50 of electromagnetic energy may have a wavelength of 1062 nanometers, the infrared camera 70 may obtain images at 900 nanometers, and the optical filter 72 may block wavelengths of light outside of an 820 to 1000 nanometer range.

The image controller 74 of the monitoring portion 34 of the apparatus 30 is preferably a microcomputer. Alternatively, the image controller 74 may be formed from discrete circuitry, an application-specific-integrated-circuit (“ASIC”), or any other type of control circuitry. The image controller 74 is operatively coupled to the infrared camera 70 and images obtained by the infrared camera 70 are provided to the image controller 74. The image controller 74 is also operatively coupled to the weld controller 46 and communicates with the weld controller 46. As an alternative to the apparatus 30 including separate and distinct weld and image controllers 46 and 74, a single controller may form both the weld controller 46 and the image controller 74.

The image controller 74 includes an internal timer. Alternatively, a separate timer (not shown) may be operatively connected to the image controller 74. The image controller 74 controls the starting, stopping, and resetting of the timer. After being started, the timer provides the image controller 74 with signals that indicate the amount of time that has elapsed since the start of the timer.

The image controller 74 controls the infrared camera 70. The image controller 74 turns on the infrared camera 70 when the welding process begins and turns the infrared camera 70 off after the image controller 74 determines that the weld 56 has been formed. While on, the infrared camera 70 continuously obtains images and provides the images to the image controller 74. The images provided from the infrared camera 70 to the image controller 74 may be color images or may be grayscale images. Preferably, the infrared camera 70 provides the image controller 74 with color images.

The image controller 74 performs a pattern recognition algorithm on the received images. The image controller 74 analyzes various characteristics of the received images to determine whether the weld 56 is being formed properly. The various characteristics are discussed in detail below. A properly formed weld is a weld in which each analyzed characteristic conforms to associated criteria. For example, when the analyzed characteristic is the temperature of the weld pool 60, the associated criteria include threshold temperature ranges that vary over time. The threshold temperature ranges increase over time as the beam 50 of electromagnetic energy heats the first and second pieces of plastic material 10 and 12 to form the weld pool 60, then the threshold temperature ranges decreases over time after the beam 50 of electromagnetic energy is removed and the weld pool 60 begins to cool and harden into the weld 56.

In addition to analyzing the various characteristics of the received images, the image controller 74 also provides feedback signals to the weld controller 46. The feedback signals indicate to the weld controller 46 that an analyzed characteristic is out of conformance with its associated criteria, a location in the weld pool 60 of the nonconforming characteristic, and a description of the nonconforming characteristic, e.g., low temperature.

As stated above, one characteristic of the obtained images that the image controller 74 analyzes is the temperature of the weld pool 60. When the infrared camera 70 provides color images to the image controller 74, the image controller 74 analyzes the color of each pixel of the received image to determine the temperature associated with the pixel. The image controller 74 then compares the determined temperatures of the pixels associated with the weld pool 60 to a threshold temperature range to determine whether the determined temperatures are within the threshold temperature range. Since the obtained image includes the weld pool 60, in its entirety, the image controller 74 monitors the temperature of the entire weld pool 60. This enables the image controller 74 to determine whether any portion of the weld pool 60 is at a temperature outside of the threshold temperature range, whether too low or too high. When the image controller 74 determines that a portion of the weld pool 60 is outside of the threshold temperature range, the image controller 74 provides a feedback signal to the weld controller 46.

The weld controller 46 is responsive to the feedback signal from the image controller 74 for adjusting the welding process. For example, when the feedback signal from the image controller 74 indicates that the temperature of the nonconforming portion of the weld pool 60 is too low, the weld controller 46 may increase the time that the beam 50 of electromagnetic energy is concentrated on the nonconforming portion of the weld pool 60. Similarly, when the feedback signal from the image controller 74 indicates that the temperature of the nonconforming portion of the weld pool 60 is too high, the weld controller 46 may reduce the time that the beam 50 of electromagnetic energy is concentrated on the nonconforming portion of the weld pool 60.

Another characteristic of the received images that the image controller 74 analyzes is the width of the weld pool 60. The image controller 74 determines the width of the weld pool 60 and compares the determined width to a threshold width range to determine whether the width of the weld pool 60 is within the threshold width range. Since each received image includes the entire weld pool 60, the image controller 74 analyzes the width of the weld pool 60 along the entire path of the weld pool. Again, the image controller 74 provides a feedback signal to the weld controller 74 when a determination is made that the width of a portion of the weld pool 60 is outside of the threshold width range. The weld controller 46 is responsive to the feedback signal to adjust the welding process to bring the width of the portion back into the threshold width range. Since the width of the weld pool 60 varies over time as portions of the first and second pieces of plastic material 10 and 12 melt, the threshold width range may vary over time. Alternatively, the image controller 74 may only monitor the width of the weld pool 60 after a determination has been made that the weld pool 60 has reached a predetermined temperature. When monitoring the width of the weld pool 60 only after the determination that the weld pool 60 has reached the predetermined temperature, only one threshold width range is necessary.

The image controller 74 also analyzes the received images for any voids that may be located in the weld pool 60. In response to finding a void, the image controller 74 provides a feedback signal to the weld controller 46 so that the weld controller may alter the welding process to fill the void.

In addition to providing feedback signals to the weld controller 46, the image controller 74 also provides alarm signals to the alarm device 76 of the monitoring portion 34 of the apparatus 30. The alarm device 76 is operable for providing an indication to an operator of the apparatus 30 that the image controller 74 determined the existence of a nonconforming characteristic. The alarm device 76 may provide any one or more of visual, audio, and tactile signals to the operator.

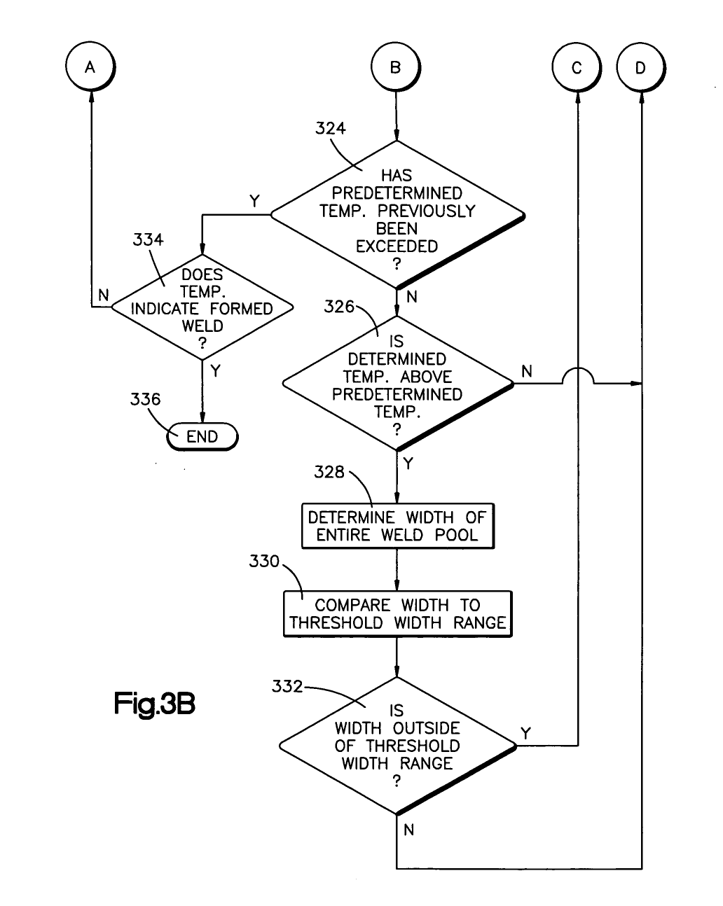

FIGS. 3A and 3B collectively form a flow diagram that illustrates an exemplary control process 300 that may be performed by the image controller 74 in accordance with the method of the present invention. The process 300 begins at step 302 in response the apparatus 30 being powered on. From step 302, the process 300 proceeds to step 304 in which a determination is made as to whether the welding process is beginning. For example, the image controller 74 may receive a signal from the weld controller 46 indicating that the welding process is beginning. When the determination at step 304 is negative, step 304 is repeated. When the determination at step 304 is affirmative, the process 300 proceeds to step 306.

At step 306, the image controller 74 actuates the infrared camera 70 to begin obtaining images. At step 308, the image controller 74 starts its internal timer and at step 310, the image controller 74 monitors the infrared camera 70 for an image. After the image controller 74 receives an image from the infrared camera 70, the process 300 proceeds to step 312 in which the image controller 74 monitors the timer to determine the time at which the infrared camera 70 obtained the image.

From step 312, the process 300 proceeds to step 314. At step 314, the image controller 74 analyzes the received image to determine the temperature of each pixel associated with the weld pool 60. Thus, in performing step 314, the image controller 74 analyzes the entire path of the weld pool 60. As stated above, when the image received by the image controller 74 is a color image, the color of each pixel of the received image indicates the temperature associated with that pixel. When the image received by the image controller 74 is a grayscale image, the intensity or brightness of the pixel indicates the temperature associated with that pixel. After the temperature of each pixel associated with the weld pool 60 has been determined, the process 300 proceeds to step 316 in which the determined temperatures are compared to a threshold temperature range for the determined image time. Since the temperature of the weld pool 60 gradually increases as the time that the beam 50 of electromagnetic energy is applied increases, the threshold temperature range varies as a function of time, as was discussed above.

At step 318, a determination is made as to whether any portion of the weld pool 60 has a temperature that is outside of the threshold temperature range for the determined image time. When the determination at step 318 is affirmative and a portion of the weld pool 60 is outside of the threshold temperature range, the process 300 proceeds to step 320 in which a feedback signal is provided to the weld controller 46 and an alarm signal is provided to the alarm device 76. As discussed above, the weld controller 46 may be responsive to the feedback signal for adjusting the weld process to correct the nonconforming portion of the weld pool 60. When the determination at step 318 is negative, the process 300 proceeds to step 322.

At step 322, a determination is made as to whether any voids are present in the weld pool 60. To determine whether any voids are present, the image controller 74 compares the pixels of the received image that represent the weld pool 60 to surrounding pixels of the weld pool to determine if any unusual differences in temperature exist. Although each pixel may be within the threshold temperature range for the determined image time, a large temperature difference between adjacent pixels may indicate the occurrence of a void, for example, a gas bubble, in the weld pool 60. When the determination at step 322 is affirmative, the process 300 proceeds to step 318 in which a feedback signal is provided to the weld controller 46 and an alarm signal is provided to the alarm device 76. When the determination at step 322 is negative, the process 300 proceeds to step 324 (FIG. 3B).

At step 324, a determination is made as to whether the temperature of the weld pool 60 has previously exceeded a predetermined temperature. The predetermined temperature is a temperature at which the width of the weld pool 60 should be fully formed, i.e., a temperature at which the width of the weld pool 60 should be within its desired range. When the determination at step 324 is negative, the process 300 proceeds to step 326. At step 326, a determination is made as to whether the temperature of the weld pool 60 is currently above the predetermined temperature. When the determination at step 326 is negative, the process 300 returns to step 310. When the determination at step 326 is affirmative, the process 300 proceeds to step 328.

At step 328, the image controller 74 determines the width of the weld pool 60, in its entirety, i.e., along the entire path of the weld pool 60. At step 330, the determined width of the weld pool 60 is compared to a threshold width range. At step 332, a determination is made as to whether the determined width of the weld pool 60 at any location along the path of the weld pool is outside of the threshold width range. When the determination at step 332 is affirmative and a portion of the weld pool 60 is determined to have a width that is outside of the threshold width range, the process 300 proceeds to step 320 in which a feedback signal is provided to the weld controller 46 and an alarm signal is provided to the alarm device 76. When the determination at step 332 is negative, the process 300 returns to step 310.

Returning to step 324, when a determination at step 324 is affirmative and the weld pool 60 has previously exceeded the predetermined temperature, the process 300 proceeds to step 334. At step 334, a determination is made as to whether the temperature of the weld pool 60 indicates that the weld 56 has been formed. More specifically, at step 334, a determination is made as to whether the weld pool 60 temperature is below a temperature at which the weld pool 60 hardens to form the weld 56. When the determination at step 334 is negative, the process 300 returns to step 310. When the determination at step 334 is affirmative, the process 300 proceeds to step 336 and the process 300 ends.

From the above description of the invention, those skilled in the art will perceive improvements, changes and modifications. Such improvements, changes and modifications within the skill of the art are intended to be covered by the appended claims.

1. Monitoring the quality of a weld being formed between first and second pieces of material, the monitoring comprising the steps of:
positioning the first and second pieces to abut each other;
heating the first and second pieces at their location of abutment to form a pool of material at the location of abutment which pool of material forms a weld between the pieces;
simultaneous with said heating step, obtaining a thermal image as the weld is being formed by collecting infrared radiation passing through the second piece of material from the weld and the pool of material; and
analyzing the obtained thermal image for characteristics indicative of an acceptable weld being formed.

2. The method of claim 1 wherein the step of obtaining a thermal image of the weld being formed further includes the step of:
obtaining a thermal image that includes, in its entirety, a weld pool that results in the weld.

3. The method of claim 2 wherein the step of obtaining a thermal image that includes the weld pool in its entirety further includes the step of:
positioning an infrared detector that is configured to detect infrared radiation having a wavelength that passes through the second piece of material on a side of the second piece of material opposite the first piece of material and in a location in which the weld pool in its entirety is within a field of view of the infrared detector.

4. The method of claim 2 wherein the step of analyzing the obtained thermal image for characteristics indicative of a properly formed weld includes the steps of:
determining a temperature of each portion of the weld pool; and
comparing the determined temperature of each portion of the weld pool with a threshold temperature range.

5. The method of claim 4 wherein the step of comparing the determined temperature of each portion of the weld pool with a threshold temperature range further includes the steps of:
determining a time at which the thermal image was obtained; and
comparing the determined temperature of each portion of the weld pool with a threshold temperature range that is associated with the determined time to determine whether the determined temperatures are within the associated threshold temperature range.

6. The method of claim 5 further including the step of:
providing a feedback signal to a weld controller in response to determining that a determined temperature is outside of the associated threshold temperature range.

7. The method of claim 2 wherein the step of analyzing the obtained thermal image for characteristics indicative of a properly formed weld includes the steps of:
determining a width of the weld pool at all locations along a path of the weld pool; and
comparing the determined widths to a threshold width range to determine whether the determined widths are within the threshold width range.

8. The method of claim 7 further including the step of:
providing a feedback signal to a weld controller in response to determining that a determined width is outside of the threshold width range.

9. The method of claim 2 wherein the step of analyzing the obtained thermal image for characteristics indicative of a properly formed weld includes the step of:
analyzing the weld pool in its entirety for indications of a void in the weld pool.

10. The method of claim 9 further including the step of:
providing a feedback signal to a weld controller in response to determining that a void exists in the weld pool.

11. The method of claim 1 further including the step of:
providing a feedback signal to a weld controller in response to determining that a characteristic fails to meet an associated criterion.

12. The method of claim 1 further including the step of:
providing an alarm signal to an alarm device in response to determining that a characteristic fails to meet an associated criterion.

13. Monitoring the quality of a weld being formed between first and second pieces of material, the monitoring comprising the steps of:
positioning the first and second plastic pieces to abut each other;
heating the first and second plastic pieces at their location of abutment to form a pool of material at their location of abutment which pool of material forms a weld between the pieces;
determining a range of wavelengths of infrared radiation that will pass through the second piece of material;
positioning an infrared detector that is configured to detect infrared radiation within the determined range of wavelengths on a side of the second piece of material opposite the first piece of material;
simultaneous with said heating step, obtaining a thermal image as the weld is being formed between the first and second pieces of material by collecting infrared radiation within the determined range of wavelengths from the weld and the pool of material; and
analyzing the obtained thermal image for characteristics indicative of an acceptable weld being formed.

14. The method of claim 13 wherein the step of obtaining a thermal image of the weld being formed further includes the step of:
obtaining a thermal image that includes, in its entirety, a weld pool that results in the weld.

15. The method of claim 14 wherein the step of analyzing the obtained thermal image for characteristics indicative of a properly formed weld includes the steps of:
determining a temperature of each portion of the weld pool; and
comparing the determined temperature of each portion of the weld pool with a threshold temperature range.

16. The method of claim 15 wherein the step of comparing the determined temperature of each portion of the weld pool with a threshold temperature range further includes the steps of:
determining a time at which the thermal image was obtained; and
comparing the determined temperature of each portion of the weld pool with a threshold temperature range that is associated with the determined time to determine whether the determined temperatures are within the associated threshold temperature range.

17. The method of claim 16 further including the step of:
providing a feedback signal to a weld controller in response to determining that a determined temperature is outside of the associated threshold temperature range.

18. The method of claim 14 wherein the step of analyzing the obtained thermal image for characteristics indicative of a properly formed weld includes the steps of:
determining a width of the weld pool at all locations along a path of the weld pool; and
comparing the determined widths to a threshold width range to determine whether the determined widths are within the threshold width range.

19. The method of claim 18 further including the step of:
providing a feedback signal to a weld controller in response to determining that a determined width is outside of the threshold width range.

20. The method of claim 14 wherein the step of analyzing the obtained thermal image for characteristics indicative of a properly formed weld includes the step of:
analyzing the weld pool in its entirety for indications of a void in the weld pool.

21. The method of claim 20 further including the step of:
providing a feedback signal to a weld controller in response to determining that a void exists in the weld pool.

22. The method of claim 13 further including the step of:
providing a feedback signal to a weld controller in response to determining that a characteristic fails to meet an associated criterion.

23. The method of claim 13 further including the step of:
providing an alarm signal to an alarm device in response to determining that a characteristic fails to meet an associated criterion.

24. The method of claim 13 wherein the step of obtaining the thermal image of the weld being formed includes the step of filtering the infrared radiation to block out the electromagnetic energy having a first wavelength that is used in heating the first and second pieces at their location of abutment to form a pool of material and a weld between the first and second pieces.
